(19) United States
(12) Patent Application Publication
(10) Pub. No.: US 2022/0084165 A1
(43) Pub. Date: Mar. 17, 2022

(54) SYSTEM AND METHOD FOR SINGLE-MODAL OR MULTI-MODAL STYLE TRANSFER AND SYSTEM FOR RANDOM STYLIZATION USING THE SAME

(71) Applicant: GUANGDONG OPPO MOBILE TELECOMMUNICATIONS CORP., LTD., Dongguan (CN)

(72) Inventors: Jenhao HSIAO, Palo Alto, CA (US); Derek YOUNG, Palo Alto, CA (US)

(21) Appl. No.: 17/534,957

(22) Filed: Nov. 24, 2021

Related U.S. Application Data
(63) Continuation of application No. PCT/CN2019/122371, filed on Dec. 2, 2019.
(60) Provisional application No. 62/854,464, filed on May 30, 2019.

(51) Int. Cl. G06T 3/40; G06T 5/50

(52) U.S. Cl. CPC G06T 3/40; G06T 2207/20221; G06T 5/50

(57) ABSTRACT

A system for style transfer performs receiving and processing, by at least one content encoder branch, at least one second content image obtained from a first content image, to generate at least one first feature map such that concrete information of the at least one second content image is reflected in the at least one first feature map; receiving and processing, by at least one style encoder branch, at least one style image, to generate at least one second feature map such that abstract information of the at least one style image is reflected in the at least one second feature map; and fusing, by each of at least one fusing block, each of the at least one first feature map and each of the at least one second feature map, to generate at least one fused feature map corresponding to the at least one second feature map.

### CROSS-REFERENCE TO RELATED APPLICATION

This application is a continuation of International Application No. PCT/CN2019/122371, filed on Dec. 2, 2019, which claims the benefit of priority to U.S. Application No. 62/854,464, filed on May 30, 2019, both of which are hereby incorporated by reference in their entireties.

### BACKGROUND

The present disclosure relates to the field of style transfer, and more particularly, to a system and method for single-modal or multi-modal style transfer and a system for random stylization using the same.

Style transfer is a technique that recomposes original images in styles of other images, and changes of the original images are not just traditional changes such as color tones or color distributions. For example, a photo capturing a scene can be recomposed into a Picasso style painting of the scene using style transfer.

### SUMMARY

An object of the present disclosure is to propose a system and method for single-modal or multi-modal style transfer and a system for random stylization using the same.

In a first aspect of the present disclosure, a system for style transfer includes at least one memory and at least one processor. The at least one memory is configured to store program instructions. The at least one processor is configured to execute the program instructions, which cause the at least one processor to perform steps including receiving and processing, by at least one content encoder branch, at least one second content image obtained from a first content image, to generate at least one first feature map such that concrete information of the at least one second content image is reflected in the at least one first feature map; receiving and processing, by at least one style encoder branch, at least one style image, to generate at least one second feature map such that abstract information of the at least one style image is reflected in the at least one second feature map; and fusing, by each of at least one fusing block, each of the at least one first feature map and each of the at least one second feature map, to generate at least one fused feature map corresponding to the at least one second feature map.

In a second aspect of the present disclosure, a system for random stylization includes at least one memory and at least one processor. The at least one memory is configured to store program instructions. The at least one processor is configured to execute the program instructions, which cause the at least one processor to perform steps including performing semantic segmentation on a content image, to generate a segmented content image including a plurality of segmented regions; randomly selecting a plurality of style images, wherein a number of the style images is equal to a number of the segmented regions; performing style transfer using the first content image and the style images, to correspondingly generate a plurality of stylized images; and synthesizing the stylized images, to generate a randomly stylized image including a plurality of regions corresponding to the segmented regions and the stylized images.

In a third aspect of the present disclosure, a computer-implemented method includes receiving and processing, by at least one content encoder branch, at least one second content image obtained from a first content image, to generate at least one first feature map such that concrete information of the at least one second content image is reflected in the at least one first feature map; receiving and processing, by at least one style encoder branch, at least one style image, to generate at least one second feature map such that abstract information of the at least one style image is reflected in the at least one second feature map; and fusing, by each of at least one fusing block, each of the at least one first feature map and each of the at least one second feature map, to generate at least one fused feature map corresponding to the at least one second feature map.

### BRIEF DESCRIPTION OF DRAWINGS

In order to more clearly illustrate the embodiments of the present disclosure or related art, the following figures will be described in the embodiments are briefly introduced. It is obvious that the drawings are merely some embodiments of the present disclosure, a person having ordinary skill in this field can obtain other figures according to these figures without paying the premise.

FIG. 1 is a block diagram illustrating inputting, processing, and outputting hardware modules in a terminal in accordance with an embodiment of the present disclosure.

FIG. 2 is a block diagram illustrating the software portion of a system for single-modal style transfer in terms of at least one module in accordance with an embodiment of the present disclosure.

FIG. 3 is a diagram illustrating an auto-encoder network in the system for single-modal style transfer in accordance with an embodiment of the present disclosure.

FIG. 4 is a diagram illustrating a stage in a content encoder branch, a style encoder branch, or a decoder of the auto-encoder network in accordance with an embodiment of the present disclosure.

FIG. 5 is a diagram illustrating a convolutional stage in the decoder of the auto-encoder network in accordance with an embodiment of the present disclosure.

FIG. 6 is a diagram illustrating a sequentially employed style encoder branch of the auto-encoder network in a system for multi-modal style transfer in accordance with an embodiment of the present disclosure.

FIG. 7 is a diagram illustrating a plurality of parallel style encoder branches same as a style encoder branch of the auto-encoder network in a system for multi-modal style transfer in accordance with an embodiment of the present disclosure.

FIG. 8 is a flowchart illustrating the software portion of a system for single-modal or multi-modal style transfer in terms of steps in accordance with an embodiment of the present disclosure.

FIG. 9 is a flowchart illustrating a software portion of a system for random stylization in accordance with an embodiment of the present disclosure.

FIG. 10 is a diagram illustrating a content image in accordance with an embodiment of the present disclosure.

FIG. 11 is a diagram illustrating a segmented content image in accordance with an embodiment of the present disclosure.

FIG. 12 is a diagram illustrating stylized images in accordance with an embodiment of the present disclosure.

FIG. 13 is a diagram illustrating a randomly stylized image in accordance with an embodiment of the present disclosure.

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the present disclosure.

As used here, the term “using” refers to a case in which an object is directly employed for performing a step, or a case in which the object is modified by at least one intervening step and the modified object is directly employed to perform the step.

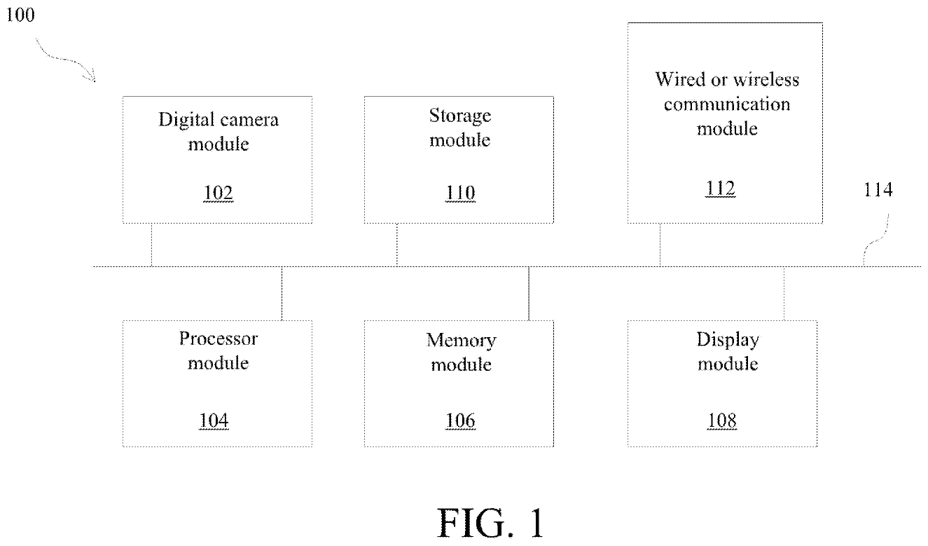

FIG. 1 is a block diagram illustrating inputting, processing, and outputting hardware modules in a terminal 100 in accordance with an embodiment of the present disclosure. Referring to FIG. 1, the terminal 100 includes a digital camera module 102, a processor module 104, a memory module 106, a display module 108, a storage module 110, a wired or wireless communication module 112, and buses 114. The terminal 100 may be cell phones, smartphones, tablets, notebook computers, desktop computers, or any electronic device having enough computing power to perform style transfer.

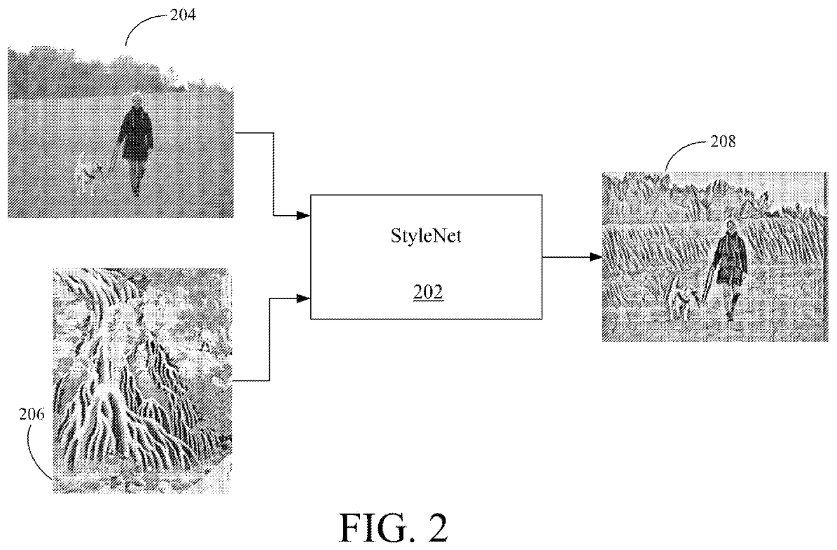

The digital camera module 102 is an inputting hardware module and is configured to capture a content image 204 (shown in FIG. 2) that is to be transmitted to the processor module 104 through the buses 114.

In an embodiment, the digital camera module 102 includes an RGB camera. Alternatively, the digital camera module 102 includes a grayscale camera. Alternatively, the content image 204 may be obtained using another inputting hardware module, such as the storage module 110, or the wired or wireless communication module 112.

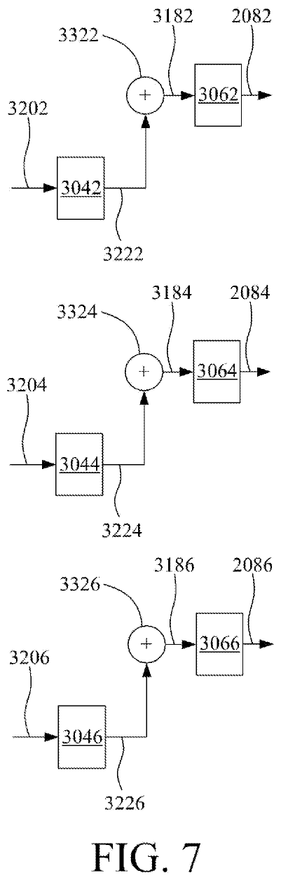

The storage module 110 is configured to store the content image 204 that is to be transmitted to the processor module 104 through the buses 114. The wired or wireless communication module 112 is configured to receive the content image 204 from a network through wired or wireless communication, wherein the content image 204 is to be transmitted to the processor module 104 through the buses 114. A plurality of content images to be described with reference to FIG. 7 may be obtained from the content image 204. That is, one of the content images may be the content image 204 and the other portion of the content images may be same as the content image 204.

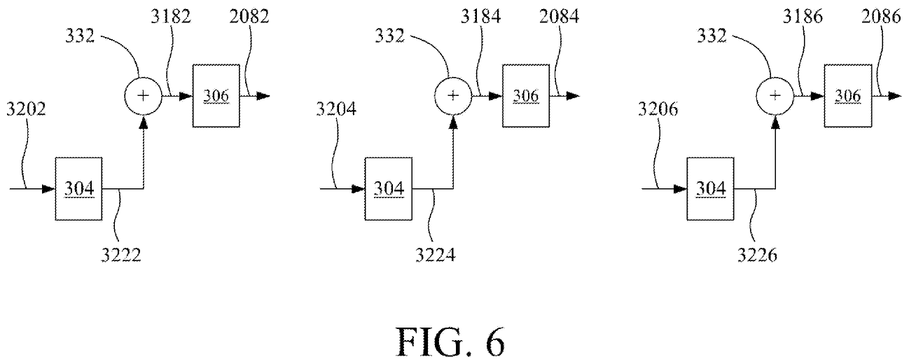

The storage module 110 is further configured to store a style image 206 (shown in FIG. 2) that is to be transmitted to the processor module 104 through the buses 114. Alternatively, the wired or wireless communication module 112 is further configured to receive a style image 206 from a network through wired or wireless communication, wherein the style image 206 is to be transmitted to the processor module 104 through the buses 114. A plurality of style images to be described with reference to FIGS. 6 and 7 may be obtained in the manner of the style image 206.

The memory module 106 may be a transitory or non-transitory computer-readable medium that includes at least one memory storing program instructions. In an embodiment, when the memory module 106 store program instructions, and the program instructions are executed by the processor module 104, the processor module 104 is configured as a StyleNet 202 (shown in FIG. 2) that performs single-modal style transfer on the content image 204 using the style image 206, to generate a stylized image 208.

In another embodiment, when the memory module 106 store program instructions and the program instructions are executed by the processor module 104, the processor module 104 is configured as a multi-StyleNet to be described with reference to FIGS. 6 and 7 that performs multi-modal style transfer on a content image using a plurality of style images, to generate a plurality of stylized images.

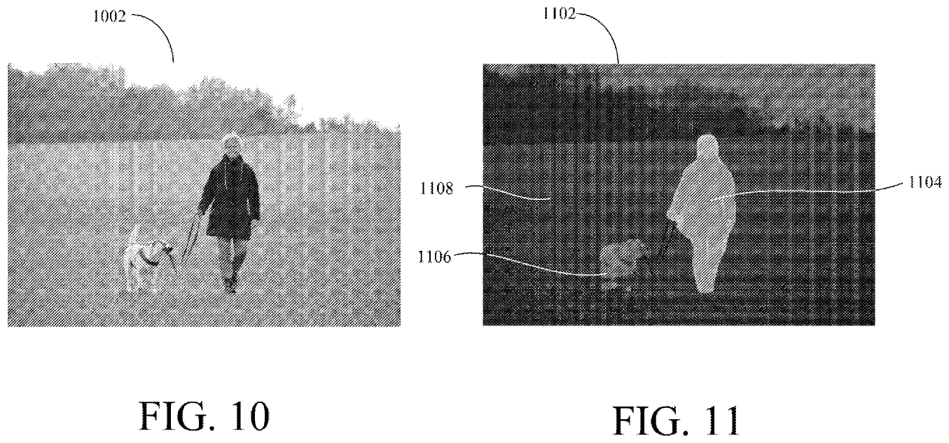

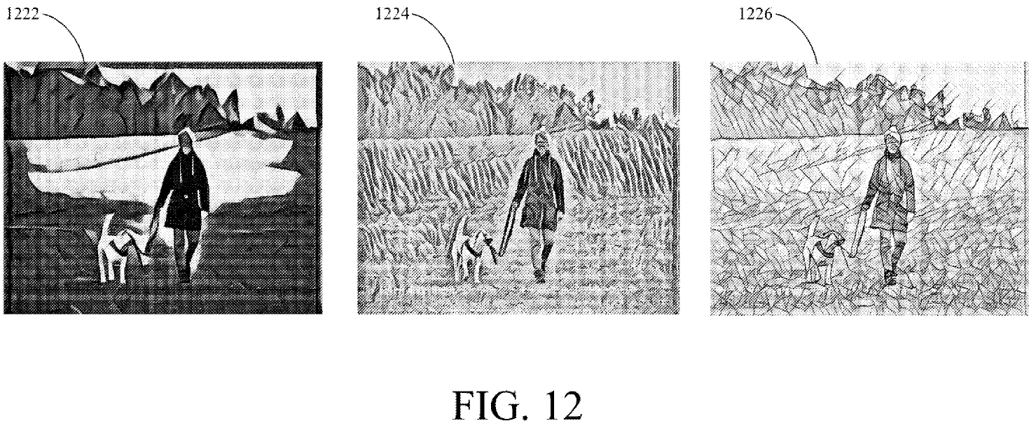

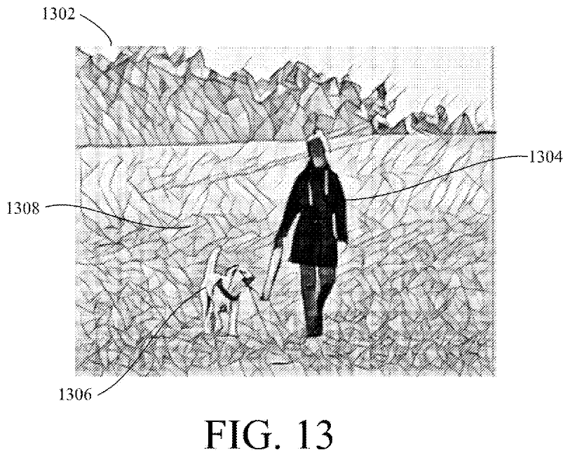

In still another embodiment, when the memory module 106 store program instructions and the program instructions are executed by the processor module 104, the processor module 104 is configured to perform random stylization on a content image 1002 (shown in FIG. 10) using plurality of style images 1222, 1224, and 1226 (shown in FIG. 12), to generate a randomly stylized image 1302 (shown in FIG. 13). The processor module 104 includes at least one processor that sends signals directly or indirectly to and/or receives signals directly or indirectly from the digital camera module 102, the memory module 106, the display module 108, the storage module 110, and the wired or wireless communication module 112 via the buses 114.

The at least one processor may be central processing unit (s) (CPU(s)), graphics processing unit(s) (GPU(s)), and/or digital signal processor(s) (DSP(s)). The CPU(s) may send the content image 204, some of the program instructions and other data or instructions to the GPU(s), and/or DSP(s) via the buses 114.

The display module 108 is an outputting hardware module that outputs through displaying. Alternatively, the storage module 110 is an outputting hardware module that outputs through storing. Still alternatively, the wired or wireless communication module 112 is an outputting module that outputs through transmitting to the network.

In an embodiment, the outputting hardware module is configured to output the stylized image 208 that is received from the processor module 104 through the buses 114.

In another embodiment, the outputting hardware module is configured to output the stylized images that are received from the processor module 104 through the buses 114. In still another embodiment, the outputting hardware module is configured to output the randomly stylized image 1402 that is received from the processor module 104 through the buses 114.

The terminal 100 is one type of computing system all of components of which are integrated together by the buses 114. Other types of computing systems such as a computing system that has a remote digital camera module instead of the digital camera module 102 are within the contemplated scope of the present disclosure.

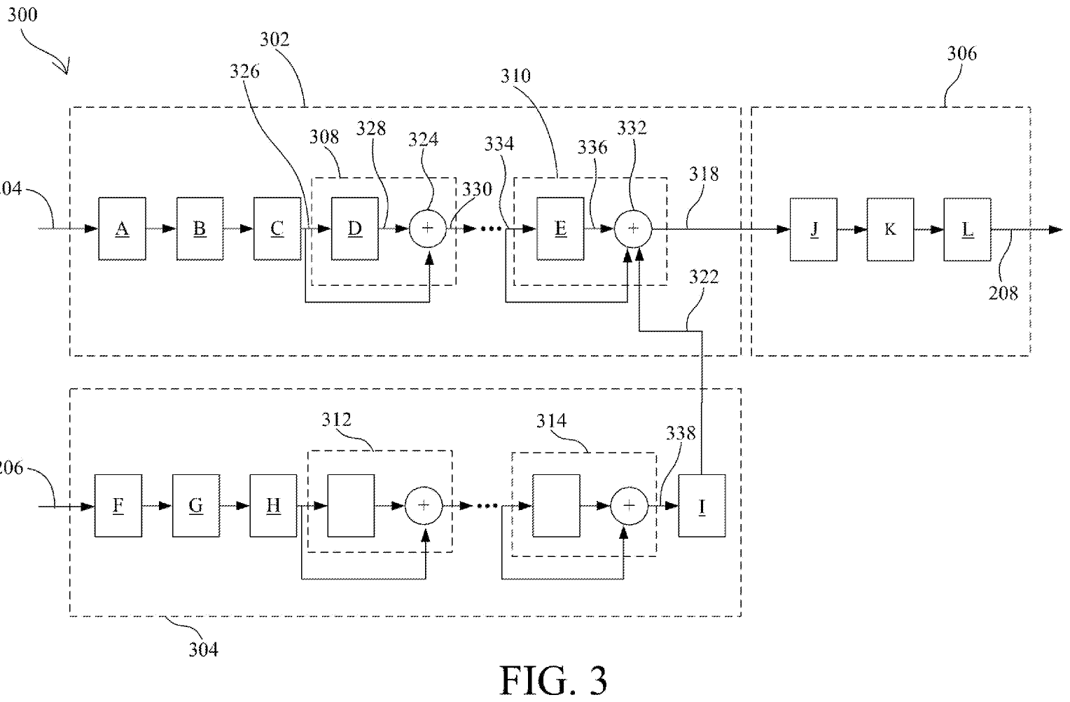

FIG. 2 is a block diagram illustrating the software portion of a system for single-modal style transfer in terms of at least one module in accordance with an embodiment of the present disclosure. Referring to FIG. 2, the software portion of a system for single-modal style transfer in terms of at least one module includes a StyleNet 202 that maps the content image 204 into the stylized image 208 subject to a restriction set forth by using the style image 206 as a modality for a style encoder branch 304 to be described with reference to FIG. 3.

FIG. 3 is a diagram illustrating an auto-encoder network 300 in the system for single-modal style transfer in accordance with an embodiment of the present disclosure. Referring to FIG. 3, in an embodiment, the StyleNet 202 (shown in FIG. 2) is the auto-encoder network 300. The auto-encoder network 300 receives the content image 204 and the style image 206, applies style transfer on the whole content image 204, and outputs a stylized image 208. The auto-encoder network 300 includes a content encoder branch 302, the style encoder branch 304, and a decoder 306. The content encoder branch 302 is configured to receive and process the content image 204, to generate a feature map 336 such that concrete information of the content image 204 is reflected in the feature map 336.

In an embodiment, the content encoder branch 302 is configured to receive and process the content image 204, to generate the feature map 336 such that only the concrete information of the content image 204 is reflected in the feature map 336.

The concrete information is low level features such as lines and edges that are used to preserve an overall spatial structure in the content image 204. The style encoder branch 304 is configured to receive and process the style image 206, to generate a feature map 322 such that abstract information of the style image 206 is reflected in the feature map 322.

In an embodiment, the style encoder branch 304 is configured to receive and process the style image 206, to generate the feature map 322 such that only the abstract information of the style image 206 is reflected in the feature map 322. The abstract information is high level features such as color, texture, and pattern that are used to preserve stylistic features in the style image 206.

The content encoder branch 302 is further configured to fuse the feature map 336 and the feature map 322, to generate a fused feature map 318. The decoder 306 is configured to receive and process the fused feature map 318, to generate the stylized image 208.

The content encoder branch 302 includes a plurality of convolutional stages A, B, and C, and a plurality of residual blocks 308 to 310.

In an embodiment, there are 9 residual blocks in the content encoder branch 302. The style encoder branch 304 includes a plurality of convolutional stages F, G, and H, a plurality of residual blocks 312 to 314, and a global pooling and duplicating stage I.

In an embodiment, there are 9 residual blocks in the style encoder branch 304. The convolutional stage A receives the content image 204, the convolutional stages A, B, and C, and the residual blocks 308 to 310 process layer-by-layer, and the residual block 310 outputs the fused feature map 318. The convolutional stage F receives the style image 206, the convolutional stages F, G, and H, the residual blocks 312 to 314, and the global pooling and duplicating stage I process layer-by-layer, and the global pooling and duplicating stage I outputs the feature map 322.

In an embodiment, the residual block 308 includes a convolutional stage D, and a summing block 324. The convolutional stage D receives a feature map 326 from the prior convolutional stage C, and outputs a feature map 328. The summing block 324 sums the feature map 326 from the prior convolutional stage C, and the feature map 328, to generate a feature map 330.

In an embodiment, the residual block 310 includes a convolutional stage E, and a summing block 332. The convolutional stage E receives a feature map 334 from a prior residual block (not shown) , and outputs a feature map 336. The summing block 332 is a fusing block that fuses a feature map generated between the content image 204 and the residual block 310, the feature map 336, and the feature map 322 by summing, to generate the fused feature map 318.

In an embodiment, the feature map generated between the content image 204 and the residual block 310 is the feature map 334 from the residual block prior to the residual block 310.

Alternatively, the fusing block may be separated from and following the summing block 332. The fusing block may fuse an output of the summing block 332 and the feature map 322 by, for example, concatenation. The residual blocks 312 and 314 are similar to the residual block 308.

The global pooling and duplicating stage I is configured to globally pool a feature map 338 output from the final residual block 314, to generate a global representation of the style image 206, and then duplicate the global representation, to generate the feature map 322 having a same size as the feature map 336.

In an embodiment, the global representation of the style image 206 is generated by global max pooling. Alternatively, the global representation of the style image 206 is generated by global average pooling.

The decoder 306 includes a plurality of deconvolutional stages J and K, and a convolutional stage L. The deconvolutional stage J receives the fused feature map 318, and the deconvolutional stages J and K, and the convolutional stage L process layer-by-layer, and the convolutional stage L outputs the stylized image 208.

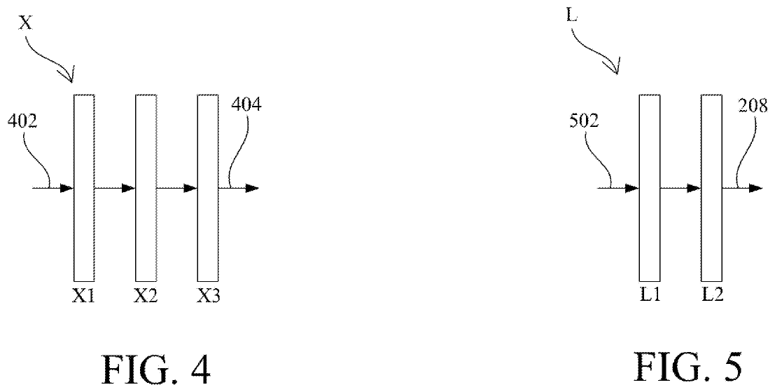

FIG. 4 is a diagram illustrating a stage X in the content encoder branch 302, the style encoder branch 304, or the decoder 306 of the auto-encoder network 300 in accordance with an embodiment of the present disclosure. The stage X may be any of the convolutional stages A, B, C, D, E, F, G, and H, and the deconvolutional stages J and K. For the convolutional stages A, B, C, D, E, F, G, and H, the stage X includes a convolutional layer X1, an instance normalization layer X2, and a nonlinear activation function layer X3. The convolutional layer X1 receives a feature map 402, the convolutional layer X1, the instance normalization layer X2, and the nonlinear activation function layer X3 process layer-by-layer, and the nonlinear activation function layer X3 outputs a feature map 404.

In an embodiment, the nonlinear activation function layer X3 is a ReLU layer.

In an embodiment, for the convolutional stages A and F, the convolutional layer X1 has a depth of 64, a kernel size of 7×7, a stride of 1×1 and a padding such that the feature map 404 have a height and a width same as those of the feature map 402.

In an embodiment, for the convolutional stages B and G, the convolutional layer X1 has a depth of 128, a kernel size of 4×4, a stride of 2×2 and a padding such that the feature map 404 is downsampled to have one half of a height and one half of a width of the feature map 402.

In an embodiment, for the convolutional stages C and H, the convolutional layer X1 has a depth of 256, a kernel size of 4×4, a stride of 2×2 and a padding such that the feature map 404 is downsampled to have one half of a height and one half of a width of the feature map 402.

In an embodiment, for the convolutional stages D and E, the convolutional layer X1 has a depth of 256, a kernel size of 3×3, a stride of 1×1 and a padding such that the feature map 404 have a height and a width same as those of the feature map 402.

In an embodiment, for the deconvolutional stages J and K, the stage X includes a deconvolutional layer X1, an instance normalization layer X2, and a nonlinear activation function layer X3. The deconvolutional layer X1 receives a feature map 402, the deconvolutional layer X1, the instance normalization layer X2, and the nonlinear activation function layer X3 process layer-by-layer, and the nonlinear activation function layer X3 outputs a feature map 404.

In an embodiment, the nonlinear activation function layer X3 is a ReLU layer.

In an embodiment, for the deconvolutional stage J, the deconvolutional layer X1 has a depth of 128, a kernel size of 4×4, a stride of 2×2 and a padding such that the feature map 404 is upsampled to have twice a height and twice a width of the feature map 402.

In an embodiment, for the deconvolutional stage K, the deconvolutional layer X1 has a depth of 64, a kernel size of 4×4, a stride of 2×2 and a padding such that the feature map 404 is upsampled to have twice a height and twice a width of the feature map 402.

The auto-encoder network 300 is exemplary. Other auto-encoder networks such as auto-encoder networks with different number of stages, different number of residual blocks, convolutional layers with different hyperparameters, and/or deconvolutional layers with different hyperparameters are within the contemplated scope of the present disclosure.

FIG. 5 is a diagram illustrating the convolutional stage L in the decoder 306 of the auto-encoder network 300 in accordance with an embodiment of the present disclosure. The convolutional stage L includes a convolutional layer L1 and a nonlinear activation function layer L2. The convolutional layer L1 receives a feature map 502, the convolutional layer L1 and the nonlinear activation function layer L2 process layer-by-layer, the nonlinear activation function layer L2 outputs the stylized image 208.

In an embodiment, the convolutional layer L1 has a depth of the content image 204, a kernel size of 7×7, a stride of 1×1 and padding such that the stylized image 208 have a height and a width same as those of the feature map 502. In an embodiment, the nonlinear activation function layer L2 is a hyperbolic tangent layer.

The software portion of the system for single-modal style transfer described with reference to FIGS. 2 to 5 may be extended into a software portion of a system for multi-modal style transfer by sequentially employing the style encoder branch 304 of the auto-encoder network 300 for a plurality of different style images, or creating a plurality of parallel style encoder branches same as the style encoder branch 304 of the auto-encoder network 300 for a plurality of different style images.

FIG. 6 is a diagram illustrating the sequentially employed style encoder branch 304 of the auto-encoder network 300 in a system for multi-modal style transfer in accordance with an embodiment of the present disclosure.

The auto-encoder network 300 in the system for multi-modal style transfer is a multi-StyleNet. Referring to FIGS. 3 and 6, compared to the auto-encoder network 300 in the system for single-modal style transfer described reference to FIG. 3, the auto-encoder network 300 in the system for multi-modal style transfer employs the style encoder branch 304, the summing block 332, and the decoder 306 sequentially.

The style encoder branch 304 is configured to sequentially receive and process a plurality of different style images 3202, 3204 and 3206, to generate a plurality of feature maps 3222, 3224, and 3226 corresponding to the different style images 3202, 3204, and 3206.

The summing block 332 is configured to sequentially fuse the feature map 336 and each of the feature maps 3222, 3224, and 3226, to generate a plurality of fused feature maps 3182, 3184, and 3186 corresponding to the feature maps 3222, 3224, and 3226. The decoder 306 is configured to sequentially receive and process the fused feature maps 3182, 3184, and 3186, to generate a plurality of different stylized images 2802, 2804, and 2806 corresponding to the fused feature maps 3182, 3184, and 3186.

In an embodiment, the feature map 336 generated by the content encoder branch 302 is reused for the style images 3204 and 3206. Alternatively, the content encoder branch 302 receives and processes the content image 204, to generate the feature map 336 for each of the style images 3202, 3204 and 3206.

FIG. 7 is a diagram illustrating a plurality of parallel style encoder branches same as the style encoder branch 304 of the auto-encoder network 300 in a system for multi-modal style transfer in accordance with an embodiment of the present disclosure.

The auto-encoder network in the system for multi-modal style transfer is a multi-StyleNet.

Referring to FIGS. 3 and 7, compared to the auto-encoder network 300 in the system for single-modal style transfer described reference to FIG. 3, an auto-encoder network in the system for multi-modal style transfer includes the content encoder branch 302 without the summing block 332, a plurality of parallel style encoder branches 3042, 3044, and 3046 same as the style encoder branch 304, a plurality of parallel summing blocks 3322, 3324, and 3326 same as the summing block 332, and a plurality of parallel decoders 3062, 3064, and 3066 same as the decoder 306.

The style encoder branches 3042, 3044, and 3046 corresponding to the different style images 3202, 3204, and 3206 are configured to receive and process the style images 3202, 3204, and 3206, to generate a plurality of feature maps 3222, 3224, and 3226 corresponding to the different style images 3202, 3204, and 3206.

The summing blocks 3322, 3324, and 3326 are each configured to fuse the feature map 336, and each of the feature maps 3222, 3224, and 3226, to generate a plurality of fused feature maps 3182, 3184, and 3186 corresponding to the feature maps 3222, 3224, and 3226.

The decoders 3062, 3064, and 3066 are configured to receive and process the fused feature maps 3182, 3184, and 3186, to generate a plurality of different stylized images 2802, 2804, and 2806 corresponding to the fused feature maps 3182, 3184, and 3186.

In an embodiment, the feature map 336 generated by the content encoder branch 302 is reused for the style images 3204 and 3206. Alternatively, a plurality of content encoder branches same as the content encoder branch 302 generate a plurality of feature maps same as the feature map 336 for the style images 3202, 3204 and 3206.

In an embodiment, any of the auto-encoder networks in the systems for single-modal and multi-modal style transfer described with reference to FIGS. 2 to 7 are trained using loss functions such as a content loss and a style loss. The content loss is a (squared, normalized) Euclidean distance between feature representations. The style loss is a squared Frobenius norm of a difference between Gram matrices of output and target images.

In an embodiment, the loss functions further include a total variation loss. The auto-encoder networks in the systems for single-modal and multi-modal style transfer are trained for many different style images.

After training, parameters of any of the auto-encoder networks in the systems for single-modal and multi-modal style transfer are frozen, and any of the auto-encoder networks in the systems for single-modal and multi-modal style transfer is deployed to the terminal 100 (shown in FIG. 1).

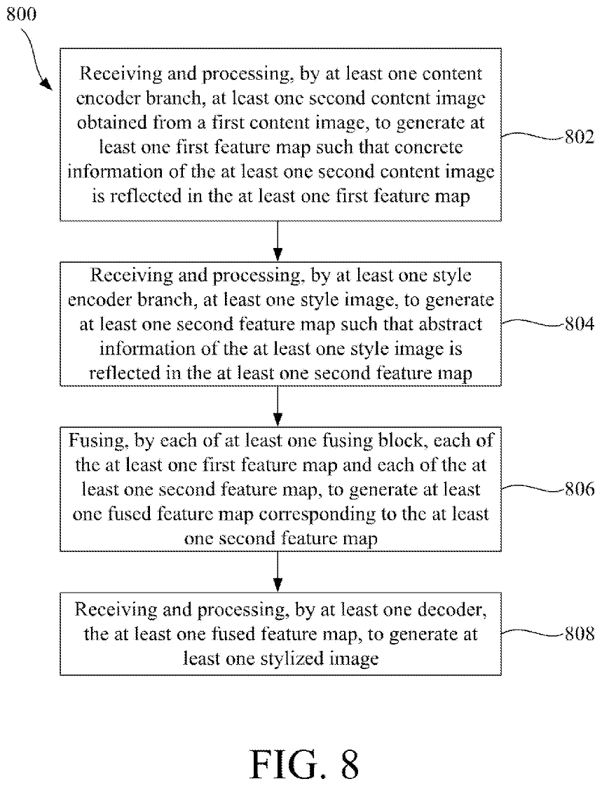

FIG. 8 is a flowchart illustrating the software portion 800 of the system for single-modal or multi-modal style transfer in terms of steps in accordance with an embodiment of the present disclosure. Referring to FIGS. 2 to 8, the software portion 800 of the system for single-modal or multi-modal style transfer in terms of steps includes the following steps.

In step 802, the at least one second content image obtained from a first content image is received and processed by at least one content encoder branch, to generate at least one first feature map such that concrete information of the at least one second content image is reflected in the at least one first feature map.

For the system for single-modal style transfer described with reference to FIG. 3, there are one second content image 204 obtained from the first content image 204, one content encoder branch 302, and one first feature map 336.

For the system for multi-modal style transfer described with reference to FIG. 6, there are one second content image 204 obtained from the first content image 204 and one content encoder branch 302 that are used once, and one first feature map 336 that is reused. Alternatively, there are one second content image 204 obtained from the first content image 204, one content encoder branch 302, and one first feature map 336 that are sequentially used.

For the system for multi-modal style transfer described with reference to FIG. 7, there are one second content image 204 obtained from the first content image 204 and one content encoder branch 302 that are used once, and one first feature map 336 that is reused. Alternatively, there are a plurality of second content images obtained from the first content image 204, a plurality of content encoder branches same as the content encoder branch 302, and a plurality of feature maps same as the feature map 336.

In step 804, the at least one style image is received and processed by at least one style encoder branch, to generate at least one second feature map such that abstract information of the at least one style image is reflected in the at least one second feature map.

For the system for single-modal style transfer described with reference to FIG. 3, there are one style image 206, one style encoder branch 304, and one second feature map 322.

For the system for multi-modal style transfer described with reference to FIG. 6, there are a plurality of different style images 3202, 3204, and 3206, one style encoder branch 304, and a plurality of second feature maps 3222, 3224, and 3226. For the system for multi-modal style transfer described with reference to FIG. 7, there are a plurality of different style images 3202, 3204, and 3206, a plurality of style encoder branch 3042, 3044, and 3046 same as the style encoder branch 304, and a plurality of second feature maps 3222, 3224, and 3226.

In step 806, each of the at least one first feature map and each of the at least one second feature map are fused by each of at least one fusing block, to generate at least one fused feature map corresponding to the at least one second feature map.

For the system for single-modal style transfer described with reference to FIG. 3, there are the one first feature map 336, the one second feature map 322, one fusing block which is a summing block 332, and one fused feature map 318.

For the system for multi-modal style transfer described with reference to FIG. 6, there are the one first feature map 336, the second feature maps 3222, 3224, and 3226, the one fusing block which is a summing block 332, and a plurality of fused feature maps 3182, 3184, and 3186.

For the system for multi-modal style transfer described with reference to FIG. 7, there are the one first feature map 336 or the feature maps same as the feature map 336, the second feature maps 3222, 3224, and 3226, and a plurality of fusing blocks which are a plurality of summing blocks 3322, 3324, and 3326.

In step 808, the at least one fused feature map is received and processed by at least one decoder, to generate at least one stylized image.

For the system for single-modal style transfer described with reference to FIG. 3, there are the one fused feature map 318, one decoder 306, and one stylized image 208.

For the system for multi-modal style transfer described with reference to FIG. 6, there are the fused feature maps 3182, 3184, and 3186, one decoder 306, and a plurality of stylized images 2082, 2084, and 2086. For the system for multi-modal style transfer described with reference to FIG. 7, there are the fused feature maps 3182, 3184, and 3186, a plurality of decoders 3062, 3064, and 3066 same as the decoder 306, and a plurality of stylized images 2082, 2084, and 2086.

The embodiments described with reference to FIGS. 1 to 8 have the following advantages. By subjecting the content encoder branch 302 and the decoder 306 to a restriction set forth by using a style image as a modality for the style encoder branch 304, the style image may be modified while the parameters of the content encoder branch 302, the style encoder branch 304, and the decoder 306 are fixed.

When there are, for example, 10 different style images, the traditional style transfer systems such as those in “Aneural algorithm of artistic style,” Leon A. Gatys, Alexander S. Ecker, Matthias Bethge, arXiv preprint arXiv: 1508.06576 [cs. CV], 2015 and “Perceptual losses for real-time style transfer and super-resolution,” Justin Johnson, Alexandre Alahi, Li Fei-Fei, arXiv preprint arXiv: 1603.08155 [cs. CV], 2016 need to be trained to have 10 different sets of parameters for the 10 different style images.

Compared to the traditional style transfer systems, the embodiments described with reference to FIGS. 1 to 8 have one fixed set of parameters for the 10 different style images. Therefore, the embodiments described with reference to FIGS. 1 to 8 are more convenient and use less memory space.

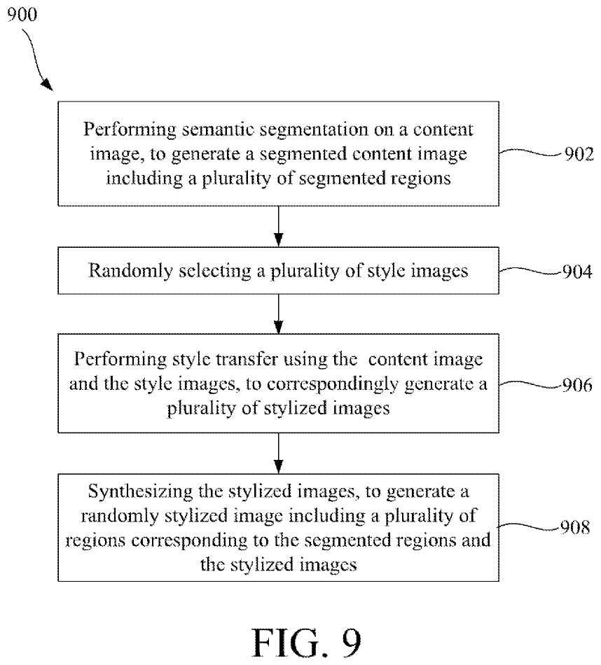

FIG. 9 is a flowchart illustrating a software portion 900 of a system for random stylization in accordance with an embodiment of the present disclosure.

In step 902, semantic segmentation is performed on a content image, to generate a segmented content image including a plurality of segmented regions.

In step 904, a plurality of style images are randomly selected. A number of the style images is equal to a number of the segmented regions.

In step 906, style transfer is performed using the content image and the style images, to correspondingly generate a plurality of stylized images.

In step 908, the stylized images are synthesized, to generate a randomly stylized image including a plurality of regions corresponding to the segmented regions and the stylized images.

FIG. 10 is a diagram illustrating the content image 1002 in accordance with an embodiment of the present disclosure.

FIG. 11 is a diagram illustrating the segmented content image 1102 in accordance with an embodiment of the present disclosure.

Referring to FIGS. 9 to 11, in step 902, semantic segmentation is performed on the content image 1002, to generate the segmented content image 1102 including a plurality of segmented regions 1104, 1106, and 1108.

In an embodiment, semantic segmentation is performed by a convolutional neural network that performs spatial pyramid pooling at several grid scales, applying several parallel atrous convolutions with different rates.

The convolutional neural network is trained to identify the most common objects in daily life. Other neural networks such as a neural network that uses an encoder-decoder structure to perform semantic segmentation are within the contemplated scope of the present disclosure.

Referring to FIGS. 9 and 11, in step 904, a plurality of style images are randomly selected. In an embodiment, a number of the style images is equal to a number of the segmented regions 1104, 1106, and 1108. In an embodiment, when there are enough number of different style images, non-repeat random selection is used to select the style images corresponding to the segmented regions 1104, 1106, and 1108.

In an embodiment, when there are not enough number of different style images, the different style images are selected for the style images corresponding to the segmented regions 1104, 1106, and 1108, and a portion of the different style images are randomly selected to repeat in the style images.

FIG. 12 is a diagram illustrating the stylized images 1222, 1224, and 1226 in accordance with an embodiment of the present disclosure. Referring to FIGS. 2 to 9, and 12, in step 906, the system for multi-modal style transfer described in any of the embodiments in FIGS. 6 and 7 performs style transfer using the content image 204 and the style images to correspondingly generate a plurality of stylized images.

Referring to FIGS. 6 and 7, in an embodiment, all of different style images 3202, 3204, and 3206 of the style images are processed by the system for multi-modal style transfer, to generate the stylized images 2082, 2084, and 2086.

The stylized images 1222, 1224, and 1226 are an example of the stylized images 2082, 2084, and 2086. The style transfer system in any of the embodiments above includes the auto-encoder network that has a fixed set of parameters for different style images. Other style transfer systems such as a style transfer system that includes a convolutional neural network that has different sets of parameters for different style images are within the contemplated scope of the present disclosure.

FIG. 13 is a diagram illustrating the randomly stylized image 1302 in accordance with an embodiment of the present disclosure. In step 908, the stylized images 1222, 1224, and 1226 are synthesized, to generate a randomly stylized image 1302 including a plurality of regions 1304, 1306, and 1308 corresponding to the segmented regions 1104, 1106, and 1108, and the stylized images 1222, 1224, and 1226.

In an embodiment, the step 908 includes the following steps. In step 9082, the stylized images are randomly assigned to the segmented regions 1104, 1106, and 1108. In step 9084, the randomly assigned stylized images are synthesized such that the regions of the randomly stylized image are corresponding to the randomly assigned stylized images.

In an embodiment, for each of the segmented regions 1104, 1106, and 1108, a corresponding mask excluding only the segmented region 1104, 1106, or 1108 is created. The randomly assigned stylized images are synthesized using the masks.

The embodiments described with reference to FIGS. 9 to 13 have the following advantages. By randomly stylizing semantically segmented regions of the content image, the content image may be stylized using style images that are arranged through combination and permutation, and stylization is instance-aware.

When there are, for example, 10 different style images, only 10 stylized images may be generated for a content image using traditional stylization. Compared to traditional stylization, the embodiments described with reference to FIGS. 9 to 13 may generate 720 different stylized images for a content image that is semantically segmented to have 3 segmented regions. Therefore, a user may expand his/her ability to customize his/her photos (i.e. content images) beyond basic number of ways to stylize the photos, allowing his/her to gain inspiration for how different photos can look under an arrangement of different styles.

Oftentimes, applying style transfer onto a photo may have widely varying results given both the content of the photo itself (lighting, colors, objects in the photo, etc.) as well as the selected style to be applied. In certain circumstances, this may potentially make it difficult for the user to decide which style they believe is best for the photo without a long period of trial and error.

Random stylization helps guiding the user by allowing him or her to quickly experiment with arrangements of styles and gain inspiration on what styles work better than others. Furthermore, because stylization is instance-aware, random art may both add emphasis to certain objects as well as allow the user to see how different styles are expressed on different objects.

Some embodiments have one or a combination of the following features and/or advantages. In a first embodiment, a system for style transfer performs receiving and processing a style image by a style encoder branch. Therefore, the style image may be modified while parameters for a content encoder branch, the style encoder branch, and the decoder are fixed. Compared to the traditional style transfer systems, the first embodiment described above is more convenient and use less memory space.

In a second embodiment, a system for random stylization performs synthesizing stylized images, to generate a randomly stylized image including a plurality of regions corresponding to segmented regions and the stylized images. The stylized images are generated using randomly selected style images. The segmented regions are generated by semantically segmenting a content image. Compared to traditional stylization, the second embodiment described above expands a user's ability to customize his/her photos (i.e. content images) beyond basic number of ways to stylize the photos, allowing his/her to gain inspiration for how different photos can look under an arrangement of different styles.

A person having ordinary skill in the art understands that each of the units, modules, layers, blocks, algorithm, and steps of the system or the computer-implemented method described and disclosed in the embodiments of the present disclosure are realized using hardware, firmware, software, or a combination thereof. Whether the functions run in hardware, firmware, or software depends on the condition of application and design requirement for a technical plan. A person having ordinary skill in the art can use different ways to realize the function for each specific application while such realizations should not go beyond the scope of the present disclosure.

It is understood that the disclosed system, and computer-implemented method in the embodiments of the present disclosure can be realized with other ways. The above-mentioned embodiments are exemplary only. The division of the modules is merely based on logical functions while other divisions exist in realization. The modules may or may not be physical modules. It is possible that a plurality of modules are combined or integrated into one physical module. It is also possible that any of the modules is divided into a plurality of physical modules. It is also possible that some characteristics are omitted or skipped. On the other hand, the displayed or discussed mutual coupling, direct coupling, or communicative coupling operate through some ports, devices, or modules whether indirectly or communicatively by ways of electrical, mechanical, or other kinds of forms.

The modules as separating components for explanation are or are not physically separated. The modules are located in one place or distributed on a plurality of network modules. Some or all of the modules are used according to the purposes of the embodiments.

If the software function module is realized and used and sold as a product, it can be stored in a computer readable storage medium. Based on this understanding, the technical plan proposed by the present disclosure can be essentially or partially realized as the form of a software product. Or, one part of the technical plan beneficial to the conventional technology can be realized as the form of a software product.

The software product is stored in a computer readable storage medium, including a plurality of commands for at least one processor of a system to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program instructions.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

What is claimed is:

1. A system for style transfer, comprising:
at least one memory configured to store program instructions; and
at least one processor configured to execute the program instructions, which cause the at least one processor to perform steps comprising:
receiving and processing, by at least one content encoder branch, at least one second content image obtained from a first content image, to generate at least one first feature map such that concrete information of the at least one second content image is reflected in the at least one first feature map;
receiving and processing, by at least one style encoder branch, at least one style image, to generate at least one second feature map such that abstract information of the at least one style image is reflected in the at least one second feature map; and
fusing, by each of at least one fusing block, each of the at least one first feature map and each of the at least one second feature map, to generate at least one fused feature map corresponding to the at least one second feature map.

2. The system of claim 1, wherein:
there are a plurality of different style images;
there is only one style encoder branch or a plurality of style encoder branches which are same and corresponding to the style images;
there are a plurality of second feature maps corresponding to the style images;
there is only one fusing block or a plurality of fusing blocks corresponding to the second feature maps; and
there are a plurality of fused feature maps.

3. The system of claim 2, wherein:
there is only one second content image;
there is only one content encoder branch; and
there is only one first feature map.

4. The system of claim 1, wherein the step of fusing, by each of at least one fusing block, each of the at least one first feature map and each of the at least one second feature map, to generate at least one fused feature map corresponding to the at least one second feature map comprises:
summing, by each of at least one summing block, each of the at least one first feature map and each of the at least one second feature map, to generate at least one summed feature map corresponding to the at least one second feature map.

5. The system of claim 4, wherein:
one of the at least one content encoder branch comprises a residual block that comprises one of the at least one summing block; and
the step of summing, by each of at least one summing block, each of the at least one first feature map and each of the at least one second feature map, to generate at least one summed feature map corresponding to the at least one second feature map comprises:
summing, by each of at least one summing block, each of the at least one first feature map, each of the at least one second feature map, and each of at least one third feature map, to generate at least one summed feature map corresponding to the at least one second feature map, wherein one of the at least one third feature map is generated between one of the at least one content image and the residual block.

6. The system of claim 1, wherein one of the at least one style encoder branch comprises a global pooling and duplicating stage that outputs one of the at least one second feature map.

7. The system of claim 1, further comprising:
receiving and processing, by at least one decoder, the at least one fused feature map, to generate at least one stylized image.

8. A system for random stylization, comprising:
at least one memory configured to store program instructions; and
at least one processor configured to execute the program instructions, which cause the at least one processor to perform steps comprising:
performing semantic segmentation on a content image, to generate a segmented content image comprising a plurality of segmented regions;
randomly selecting a plurality of style images, wherein a number of the style images is equal to a number of the segmented regions;
performing style transfer using the content image and the style images, to correspondingly generate a plurality of stylized images; and
synthesizing the stylized images, to generate a randomly stylized image comprising a plurality of regions corresponding to the segmented regions and the stylized images.

9. The system of claim 8, wherein the step of performing style transfer using the content image and the style images, to correspondingly generate the stylized images comprises:
receiving and processing, by at least one content encoder branch, at least one second content image obtained from a first content image, to generate at least one first feature map such that concrete information of the at least one second content image is reflected in the at least one first feature map;
receiving and processing, by only one style encoder branch or a plurality of style encoder branches, all of different style images of the style images, to generate a plurality of second feature maps corresponding to the different style images such that abstract information of the different style images are reflected in the second feature maps, wherein the style encoder branches are same and correspond to the different style images;
fusing, by only one fusing block or each of a plurality of fusing blocks corresponding to the second feature maps, each of the at least one first feature map and each of the second feature maps, to generate a plurality of fused feature maps corresponding to the second feature maps; and
receiving and processing, by only one decoder or a plurality of decoders which are same and corresponding to the fused feature maps, the fused feature maps, to generate a plurality of different stylized images in the stylized images and corresponding to the fused feature maps.

10. The system of claim 9, wherein:
there is only one second content image;
there is only one content encoder branch; and
there is only one first feature map.

11. The system of claim 9, wherein the step of fusing, by each of at least one fusing block, each of the at least one first feature map and each of the second feature maps, to generate a plurality of fused feature maps corresponding to the second feature maps comprises:
summing, by each of at least one summing block, each of the at least one first feature map and each of the second feature maps, to generate a plurality of summed feature maps corresponding to the second feature maps.

12. The system of claim 11, wherein
one of the at least one content encoder branch comprises a residual block that comprises one of the at least one summing block; and
the step of summing, by each of at least one summing block, each of the at least one first feature map and each of the second feature maps, to generate a plurality of summed feature maps corresponding to the second feature maps comprises:
summing, by each of at least one summing block, each of the at least one first feature map, each of the second feature maps, and each of a plurality of third feature maps, to generate a plurality of summed feature maps corresponding to the second feature maps, wherein one of the third feature maps is generated between one of the at least one content image and the residual block.

13. The system of claim 8, wherein one of the at least one style encoder branch comprises a global pooling and duplicating stage that outputs one of the at least one second feature map.

14. The system of claim 8, wherein the step of synthesizing the stylized images, to generate the randomly stylized image comprising the regions corresponding to the segmented regions and the stylized images comprises:
randomly assigning the stylized images to the segmented regions; and
synthesizing the randomly assigned stylized images such that the regions of the randomly stylized image are corresponding to the randomly assigned stylized images.

15. A computer-implemented method, comprising:
receiving and processing, by at least one content encoder branch, at least one second content image obtained from a first content image, to generate at least one first feature map such that concrete information of the at least one second content image is reflected in the at least one first feature map;
receiving and processing, by at least one style encoder branch, at least one style image, to generate at least one second feature map such that abstract information of the at least one style image is reflected in the at least one second feature map; and
fusing, by each of at least one fusing block, each of the at least one first feature map and each of the at least one second feature map, to generate at least one fused feature map corresponding to the at least one second feature map.

16. The computer-implemented method of claim 15, wherein:
there are a plurality of different style images;
there is only one style encoder branch or a plurality of style encoder branches which are same and corresponding to the style images;
there are a plurality of second feature maps corresponding to the style images;
there is only one fusing block or a plurality of fusing blocks corresponding to the second feature maps; and
there are a plurality of fused feature maps.

17. The computer-implemented method of claim 16, wherein:
there is only one second content image;
there is only one content encoder branch; and
there is only one first feature map.

18. The computer-implemented method of claim 15, wherein the step of fusing, by each of at least one fusing block, each of the at least one first feature map and each of the at least one second feature map, to generate at least one fused feature map corresponding to the at least one second feature map comprises:
summing, by each of at least one summing block, each of the at least one first feature map and each of the at least one second feature map, to generate at least one summed feature map corresponding to the at least one second feature map.

19. The computer-implemented method of claim 18, wherein:
one of the at least one content encoder branch comprises a residual block that comprises one of the at least one summing block; and
the step of summing, by each of at least one summing block, each of the at least one first feature map and each of the at least one second feature map, to generate at least one summed feature map corresponding to the at least one second feature map comprises:
summing, by each of at least one summing block, each of the at least one first feature map, each of the at least one second feature map, and each of at least one third feature map, to generate at least one summed feature map corresponding to the at least one second feature map, wherein one of the at least one third feature map is generated between one of the at least one content image and the residual block.

20. The computer-implemented method of claim 15, wherein one of the at least one style encoder branch comprises a global pooling and duplicating layer that outputs one of the at least one second feature map.
